(19) United States
(12) Patent Application Publication
(10) Pub. No.: US 2026/0290868 A1
(43) Pub. Date: Sep. 24, 2026

(54) SELECTIVE TRANSPORT LAYER FOR A PROTON EXCHANGE MEMBRANE

(71) Applicant: GM Global Technology Operations LLC, Detroit, MI (US)

(72) Inventors: Anusorn Kongkanand, Rochester Hills, MI (US); Yunzhu Zhang, Rochester Hills, MI (US); Wenbin Gu, Sterling Heights, MI (US); Phuong Quynh Ngo, Auburn Hills, MI (US)

(21) Appl. No.: 19/083,693

(22) Filed: Mar. 19, 2025

(51) Int. Cl. H01M 8/1041; B60R 16/03; C25B 9/23; C25B 9/77; C25B 13/08; H01M 8/10; H01M 8/1004; H01M 8/1032; H01M 8/1039; H01M 8/1053; H01M 8/1067

(52) U.S. Cl. CPC H01M 8/1055; C25B 9/23; C25B 9/77; C25B 13/08; H01M 8/1004; H01M 8/1032; H01M 8/1039; H01M 8/1053; H01M 8/1067; B60R 16/03; H01M 2008/1095; H01M 2250/20; H01M 2300/0082; H01M 2300/0094

(57) ABSTRACT

A membrane electrode assembly, a fuel cell, and a method for forming a membrane electrode assembly is provided. The membrane electrode assembly includes a first electrode layer including a cathode layer, a second electrode layer including an anode layer, a proton exchange membrane extending between the first electrode layer and the second electrode layer, and a selective transport layer supported by the proton exchange membrane. The selective transport layer includes a composite formed from graphene oxide (GO) and sulfonated-graphene oxide (s-GO).

### GOVERNMENT FUNDING

This invention was made with government support under Agreement No. DE-EE0011106 awarded by Department of Energy. The government may have certain rights in the invention.

### INTRODUCTION

The present disclosure relates to membrane electrode layer assemblies for fuel cells and electrolyzers, and more particularly to a membrane electrode assembly having a selective transport layer.

Electrochemical fuel cells are used as electrical power sources for electric vehicles or other devices. Electrochemical fuel cells, or simply fuel cells, convert reactants in the form of fuel and oxidants into electricity. In one exemplary configuration, a fuel cell includes an anode layer, a cathode layer spaced from the anode layer, and a proton exchange membrane (PEM) separating the anode layer and cathode layer. A hydrogen-rich gas or pure hydrogen is supplied as fuel to the anode layer side of the fuel cell while oxygen is supplied to the cathode layer side. The anode layer and cathode layer form an electric circuit when a current flowing from the anode layer to the cathode layer is routed through a connected external load. The PEM prevents gas crossover and electric current flow but permits proton migration from the anode layer to the cathode layer.

Electrolyzers are devices that utilizes electricity through an electrolysis process to split water molecules into hydrogen and oxygen gases. Electrolyzers are complementary technology to fuel cells. In one exemplary configuration, a PEM electrolyzer includes an electrolytic cell having a cathode layer, an anode layer, and a PEM separating the anode layer and the cathode layer. Electrolysis occurs when electric energy is applied across the electrolytic cell. The anode layer strips the positive charged hydrogen ions (H+) from water and releases oxygen gas (O2). The PEM allows positively charged hydrogen ions (H+) to pass from the anode layer to cathode layer. The cathode layer attracts the positively charged hydrogen ions (H+) and releases hydrogen gas (H2).

Fuel cells and electrolyzers typically have a membrane electrode assembly (MEA) that includes an ionically conductive polymer membrane disposed between an anode layer and a cathode layer. Protons flow between the anode layer and cathode layer through the ionically conductive polymer membrane. The anode layer and cathode layer are formed of porous conductive materials, such as titanium fiber felt, woven graphite, graphitized sheets, or carbon paper to enable the fuel/water to disperse over the surface of the polymer membrane facing the fuel/water supply electrode layer. One or more of the electrode layers has finely divided catalyst particles, such as platinum group metals (PGM) supported on carbon particles.

While present fuel cells and electrolyzers achieve their intended purpose, there is a need for new and improved fuel cells and electrolyzers that offer improved efficiency and performance.

### SUMMARY

According to several aspects of the present disclosure, a membrane electrode assembly is provided. The membrane electrode assembly includes a first electrode layer including a cathode layer, a second electrode layer including an anode layer, a proton exchange membrane extending between the first electrode layer and the second electrode layer, and a selective transport layer supported by the proton exchange membrane. The selective transport layer includes a composite formed from graphene oxide (GO) and sulfonated-graphene oxide (s-GO).

In accordance with another aspect of the disclosure, the proton exchange membrane is formed of at least one of perfluorosulfonic acid (PFSA) polymer, a hydrocarbon-based polymer, a sulfonated aromatic polymer, a composite membrane, or a metal-organic framework (MOF).

In accordance with another aspect of the disclosure, the proton exchange membrane is between 5 and 200 microns (μm) in thickness.

In accordance with another aspect of the disclosure, the proton exchange membrane is reinforced with at least one of expanded polytetrafluoroethylene (ePTFE) or electrospun fibers.

In accordance with another aspect of the disclosure, the thickness of the selective transport layer is between 100 and 1000 times smaller than the thickness of the proton exchange membrane.

In accordance with another aspect of the disclosure, the GO and/or the s-GO materials used in the selective transport layer is partially reduced.

In accordance with another aspect of the disclosure, the selective transport layer includes a weight ratio of graphene oxide (GO) to sulfonated-graphene oxide (s-GO) of between 0.3 to 3.

In accordance with another aspect of the disclosure, the selective transport layer has a sheet size of greater than one micron (μm), a sheet thickness of less than one nanometer (nm), a sulfur content between 4-10 wt. %, and an oxygen content of between 10-30 wt. %.

In accordance with another aspect of the disclosure, the selective transport layer is disposed proximate the first electrode layer.

In accordance with another aspect of the disclosure, the selective transport layer is disposed proximate the second electrode layer.

In accordance with another aspect of the disclosure, the selective transport layer is disposed at multiple locations within the proton exchange membrane.

In accordance with another aspect of the disclosure, two selective transport layers confine a gas recombination layer in the membrane.

In accordance with another aspect of the disclosure, the selective transport layer varies in thickness across an active area of the selective transport layer.

In accordance with another aspect of the disclosure, the selective transport layer is absent in a non-active region to facilitate water transfer.

In accordance with another aspect of the disclosure, the selective transport layer is thinner at an anode/selective transport layer interface proximate a cathode inlet.

In accordance with another aspect of the disclosure, the membrane electrode assembly includes an ionomer coated on at least one of the first electrode layer or the second electrode layer, wherein the ionomer is less than one micron in thickness.

According to several aspects of the present disclosure, a fuel cell for a vehicle is provided. The fuel cell comprises a membrane electrode assembly, a first porous transport layer adjacent to the membrane electrode assembly and a first electrode layer, a first separator plate disposed adjacent to the first porous transport layer, a second porous transport layer adjacent to the membrane electrode assembly and the second electrode layer and distal from the first porous transport layer, and a second separator plate disposed adjacent to the second porous transport layer. The membrane electrode assembly includes a first electrode layer including a cathode layer, a second electrode layer including an anode layer, a proton exchange membrane extending between the first electrode layer and the second electrode layer, and a selective transport layer supported by the proton exchange membrane. The proton exchange membrane includes a perfluorosulfonic acid (PFSA) polymer. The selective transport layer includes a composite formed from graphene oxide (GO) and sulfonated-graphene oxide (s-GO), and the selective transport layer is disposed between the cathode layer and the proton exchange membrane.

In accordance with another aspect of the disclosure, the selective transport layer includes GO and s-GO materials with a sheet size of greater than one micron (μm), a sheet thickness of less than one nanometer (nm), a sulfur content between 4-20 wt. %, and an oxygen content of between 5-30 wt. %.

According to several aspects of the present disclosure, a method for forming a membrane electrode assembly is provided. The method includes forming a selective transport layer on a first side of a proton exchange membrane, placing a first electrode layer on the selective transport layer, and placing a second electrode layer on a second side of the proton exchange membrane, wherein the second side is opposite the first side. The selective transport layer includes a composite formed from graphene oxide (GO) and sulfonated-graphene oxide (s-GO).

In accordance with another aspect of the disclosure, the first electrode layer is a cathode, and the second electrode layer is an anode.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a top perspective view illustrating an example of a vehicle having an electric motor powered by a fuel cell, in accordance with the present disclosure.

FIG. 2 is a schematic view illustrating a membrane electrode assembly used in the vehicle shown in FIG. 1, wherein the membrane electrode assembly includes a selective transport layer on a proton exchange membrane, in accordance with the present disclosure.

FIG. 3 is a flowchart illustrating a method for forming the membrane electrode assembly illustrated in FIG. 2, in accordance with the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. The following description is merely exemplary in nature and is not intended to limit the present disclosure, application, or uses.

The development of membrane technology with enhanced transport selectivity presents significant challenges due to the small size of the related species (hydrated diameter <0.6 nanometers (nm)). Despite the existence of multiple concepts, none have met practical requirements. Hydrocarbon ionomers exhibit promising selectivity; however, their durability remains inadequate. Similarly, two-dimensional materials such as graphene layers demonstrate promising selectivity, but their proton conductance is insufficient for practical applications. Additionally, the small thickness (~0.1 nm) of these materials raises concerns about their ability to withstand harsh chemical and mechanical stresses. Furthermore, poor water transport has been a notable shortcoming of these concepts.

Graphene oxides (GO), a highly oxidized form of graphene, offer a potential solution for allowing favorable chemical species (e.g., protons and water) to pass through a proton exchange membrane within a membrane electrode assembly and, at the same time, hinder transport of unfavorable chemical species (e.g., H₂, O₂, N₂, Pt²⁺ ions, and the like). While maintaining a two-dimensional morphology, GO materials are significantly more porous and permeable to transport species. GO materials are sometimes formed into thicker films (a few microns) and combined with chemicals or polymers to tune their selectivity. The membrane electrode assembly, a fuel cell, and a process for forming the membrane electrode assembly disclosed herein address limitations of existing membrane technologies by leveraging the unique properties of graphene oxides to achieve better transport selectivity and durability and mitigate membrane electrode assembly degradation.

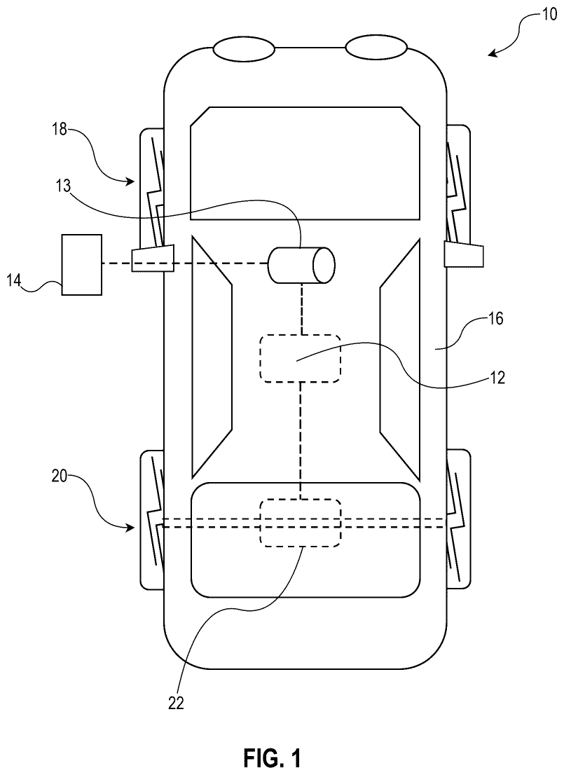

Referring to FIG. 1, a diagrammatic view of a vehicle 10 having an energy conversion device 12 is illustrated, in accordance with the present disclosure. The vehicle 10 generally includes a body 16, which has front wheels 18 and rear wheels 20. The front wheels 18 and the rear wheels 20 are each rotationally located near a respective corner of the body 16. At least one of the front wheels 18 and/or the rear wheels 20 is propelled by a motor 22 powered directly or indirectly by the energy conversion device 12. Hydrogen for the electrochemical cell to power the vehicle is supplied from a hydrogen storage tank 13. In some embodiments, vehicle 10 receives hydrogen fuel from an external electrolyzer 14 (electrolysis cells) configured to produce hydrogen that can be delivered to the hydrogen fuel storage tank 13 and/or energy conversion device 12.

In one non-limiting embodiment, the motor 22 is an electric motor, and the energy conversion device 12 is a fuel cell configured to convert a hydrogen rich fuel and oxygen from the ambient air into electricity to power the electric motor. While the vehicle 10 is depicted in the illustrated embodiment as a passenger car, other examples of vehicles include, but are not limited to, motorcycles, trucks, sport utility vehicles (SUVs), recreational vehicles (RVs), marine vessels, and aircraft. As used herein, the term “vehicle” is not limited to automobiles. While the present technology is described primarily herein in connection with electric and/or hybrid-electric vehicles, the technology is not limited to electric and hybrid-electric vehicles. The concepts can be used in a wide variety of applications, such as in connection with components used in motorcycles, mopeds, locomotives, aircraft, marine craft, and other vehicles, as well as in other applications utilizing batteries, such as in portable power stations, such as those used for powering remote job sites, emergency back-up power supplies, and permanent power stations associated with buildings and equipment, all of which may be powered by, for example, solar or wind-powered generator systems, power mains, and fuel based power generators such as gasoline, propane, kerosene, or diesel generators as well as sterling engines.

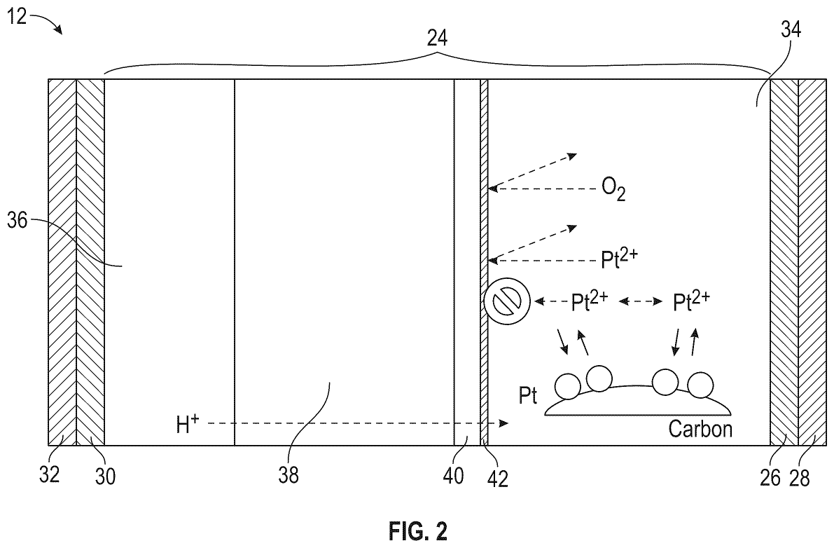

FIG. 2 is a diagrammatic illustration of a non-limiting example of the energy conversion device 12 (e.g., a fuel cell, water electrolyzer, redox flow battery, chlor-alkali cell). The energy conversion device 12 (fuel cell) is configured to receive reactant gases, for example hydrogen gas and an oxidizer gas (e.g., oxygen from ambient air). The hydrogen gas is supplied to an anode of the fuel cell, where hydrogen molecules are split into protons and electrons. The protons pass through an electrolyte membrane to a cathode. The electrons flow through an external circuit creating an electric current that can be used to power the motor 22. The oxygen can be supplied to the cathode, where the protons, some electrons, and oxygen combine to form water. The energy conversion device 12 (in case of a fuel cell) includes a membrane electrode assembly (MEA) 24, a first porous layer 26, a first separator plate 28, a second porous layer 30, and a second separator plate 32. The energy conversion device 12 and the components of the energy conversion device 12 are schematically shown and not necessarily to scale as illustrated in FIG. 2.

Still referring to FIG. 2, the MEA 24 includes a first electrode layer 34, a second electrode layer 36, a proton exchange membrane (PEM) 38, and a selective transport layer 40. The MEA 24 may also include a first porous transport layer 26 and a second porous transport layer 30.

In the MEA 24, the PEM 38 is sandwiched and extends between the first electrode layer 34 and the second electrode layer 36. In an example, the PEM 38 may include a perfluorosulfonic acid (PFSA) polymer proton permeable electrical insulator barrier or a hydrocarbon polymer variant. It will be appreciated that the PEM 38 may include other suitable materials, for example a hydrocarbon-based polymer, a sulfonated aromatic polymer, a composite membrane (e.g., incorporating inorganic fillers like silica or titanium dioxide into a polymer matrix), a metal-organic framework (MOF), or a sulfonated pentablock terpolymer. The PEM 38 may have a variety of thicknesses. In one specific example, the PEM 38 is between 5 and 200 microns (μm) in thickness. The PEM 38 may be mechanically reinforced with at least one of expanded polytetrafluoroethylene (ePTFE) or electrospun fibers.

The first electrode layer 34 and the second electrode layer 36 are electrically insulated from each other by the PEM 38. The first electrode layer 34 is a cathode (or “cathode layer”) and the second electrode layer 36 is an anode (or “anode layer”). The PEM 38 prevents both gas crossover and electric current flow but permits proton migration from the anode layer to the cathode layer. The PEM 38 allows the transport of the protons to the first electrode layer 34 (e.g., a cathode) from the second electrode layer 36 (e.g., anode) through the membrane of the PEM 38 but forces electrons to travel around a conductive path to the first electrode layer 34. Additionally, the PEM 38 serves as an insulator for electrons (e⁻) to flow through an external circuit (not shown). The PEM 38 may be comprised of a fluoropolymer proton permeable electrical insulator barrier. Alternatively, the PEM 38 may be comprised of a hydrocarbon proton permeable electrical insulator barrier. Moreover, the PEM 38 may be comprised of a sulfonic acid ionomer. It will be appreciated that the PEM 38 may include other suitable materials.

The selective transport layer 40 is supported by the proton exchange membrane 38. The selective transport layer 40 can be disposed between the first electrode layer 34 (cathode layer) and the PEM 38 in the case of a fuel cell. When the MEA 24 is utilized in an electrolyzer, the selective transport layer 40 may be disposed between the second electrode layer 36 (anode layer) and the PEM 38. The selective transport layer 40 includes a composite formed from graphene oxide (GO) and sulfonated-graphene oxide (s-GO). Graphene oxides are a highly oxidized form of graphene and significantly more porous and permeable to transport species while still possessing 2D morphology. The graphene oxides can be formed into thicker films (a few microns) and into composites with chemicals or polymers to tune their selectivity. In one example, the selective transport layer 40 includes a weight ratio (wt. %) of graphene oxide (GO) to sulfonated-graphene oxide (s-GO) of between 0.3 to 3. In one example, the selective transport layer 40 includes GO and s-GO materials with a sheet size of greater than one micron (μm), a sheet thickness of less than one nanometer (nm), a sulfur content between 4-20 wt. %, and/or an oxygen content of between 5-30 wt. %. In one example, the GO or s-GO materials in the selective transport layer 40 is partially reduced. In one example, the thickness of the selective transport layer 40 is between 100 to 1000 times smaller than the thickness of the PEM 38. In a specific example, the selective transport layer 40 is between 10 and 100 nanometers (nm) in thickness, when the PEM 38 is 10 microns (μm) in thickness. In a specific example, the selective transport layer 40 is between 180 and 1800 nanometers (nm) in thickness, when the PEM 38 is 180 microns (μm) in thickness.

While the selective transport layer 40 is shown in FIG. 2 as disposed between the PEM 38 and the first electrode layer 34 (cathode layer) (in a fuel cell), the selective transport layer 40 may be disposed in other arrangements supported by the PEM 38. For example, the selective transport layer 40 may be disposed between the PEM 38 and the second electrode layer 36 (anode layer) in the case of an electrolyzer. Additionally, the selective transport layer 40 may be disposed within the PEM 38 at multiple locations or positions, for example throughout a center portion of the PEM 38. An example specific for an electrolyzer application is the embodiment in which two selective transport layers confine a gas recombination layer in the membrane. Moreover, the selective transport layer 40 may vary in thickness across an active area of the PEM 38. In yet another example, the selective transport layer 40 may be absent in a non-active region of the PEM 38 to facilitate water transfer through the MEA 24. In one specific example, the selective transport layer 40 is thinner at an anode/selective transport layer interface that is proximate a cathode inlet (not shown).

In some instances, an ionomer layer 42 may be coated on at least a portion of the first electrode layer 34 and/or the second electrode layer 36. The ionomer layer 42 can help in conducting protons from the second electrode layer 36 (anode) to the first electrode layer 34 (cathode), which is essential for the overall reaction in a proton exchange membrane (PEM) fuel cell. Additionally, the ionomer layer 42 provides a medium for oxygen reduction reactions at the first electrode layer 34 (cathode), assists in maintaining necessary hydration levels for effective proton conduction while preventing flooding of a catalyst layer, and supports distribution of catalyst particles ensuring that they are well-dispersed and accessible. Some examples of the ionomer layer 42 used on a first electrode layer 34 (cathode) may include a sulfonated tetrafluoroethylene-based fluoropolymer-copolymer, a fluorinated ionomer such as 4,5-difluoro-2,2-bis(trifluoromethyl)-1,3-dioxole (PDD), and/or a High Oxygen Permeability Ionomer (HOPI). Some examples of an ionomer layer 42 used on a second electrode layer 36 may include a quaternary ammonium polymer such as poly(benzyltrimethylammonium) and/or poly(vinylbenzyltrimethylammonium), a polystyrene-based ionomer with a quaternary ammonium group, a poly(arylene ether sulfone) ionomer, and/or a poly(ethylene-co-tetrafluoroethylene) (ETFE) ionomer. It will be appreciated that the ionomer layer 42 may include other suitable materials for placing on an electrode layer.

The first electrode layer 34 and/or the second electrode layer 36 may be typically formed from a nanoparticle metal catalyst bound together with an ion conducting polymer. In some instances, the ion conducting polymer may be similar to the ion conducting polymer used to form the PEM 38. Additionally, the PEM 38 may include at least one catalyst. Some non-limiting examples of the catalyst may include a nanoparticle platinum group metal (PGM) catalyst, which may further include platinum (Pt) supported on carbon (C), also referred to as a Pt/C catalyst or Pt/C, ruthenium, and/or an iridium oxide (IrOx) catalyst.

As shown in FIG. 2, adjacent and/or coupled to the first electrode layer 34 is the first porous transport layer 26 that facilitates gas and fluid transport. Similarly, adjacent and/or coupled to the second electrode layer 36 is the second porous transport layer 30 that also facilitates gas and fluid transport. The first porous transport layer 26 and the second porous transport layer 30 may be made of porous, flat sheets of titanium, stainless steel, and/or nonwoven carbon paper, for example. In some instances, the first porous transport layer 26 and/or the second porous transport layer 30 may include a coating of gold or platinum (not shown).

Still referring to FIG. 2, the membrane electrode assembly (MEA) 24 may include the first separator plate 28 (or first flow field plate). The first separator plate 28 is disposed adjacent to and/or coupled to the first porous transport layer 26. The first separator plate 28 provides an adequate amount of reactants (hydrogen gas (H₂), oxygen (O₂) gas, and/or water (H₂O)) to or from the first porous transport layer 26, the second porous transport layer 30, the first electrode layer 34, and/or the second electrode layer 36 while minimizing pressure drop. The first separator plate 28 may be formed from a single unitary sheet of metal (e.g., titanium). Additionally, the first separator plate 28 and the first porous transport layer 26 define a flow field that allows water to flow from an inlet in the first separator plate 28 to the first electrode layer 34. The first separator plate 28 may include at least one channel configured to carry a fluid, for example gas or liquid.

Illustrated in FIG. 2, the membrane electrode assembly (MEA) 24 includes a second separator plate 32 (or second flow field plate). The second separator plate 32 is disposed adjacent to and/or coupled to the second porous transport layer 30. The second separator plate 32 provides an adequate amount of reactants (hydrogen (H₂), oxygen (O₂), and/or water (H₂O)) to or from the second porous transport layer 30, and/or the second electrode layer 36 while minimizing pressure drop. The second separator plate 32 may be formed from a single unitary sheet of metal (e.g., titanium) or other suitable materials. The second separator plate 32 may include at least one channel configured to carry a fluid, for example gas or liquid.

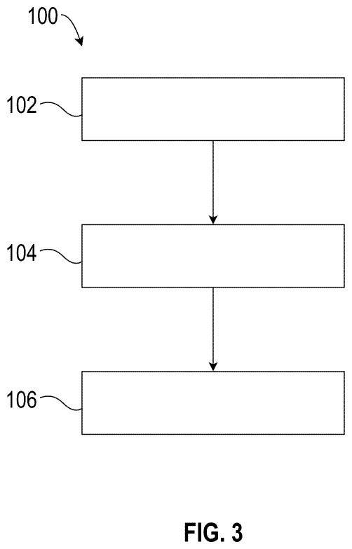

With reference to FIG. 3, a method 100 for forming the membrane electrode assembly 24 shown in FIG. 2 is presented, in accordance with the present disclosure. The method 100 starts at block 102.

Block 102 depicts forming the selective transport layer 40 on a first side of the proton exchange membrane (PEM) 38. The selective transport layer 40 includes a composite formed from graphene oxide (GO) and sulfonated-graphene oxide (s-GO). Forming the selective transport layer 40 may include preparing a dispersion of graphene oxide (GO) and sulfonated graphene oxide (s-GO) in an alcohol/water mixture. In some instances, at least one cation may be added to the mixture or dispersion to facilitate self-assembly of the graphene oxide (GO) and the sulfonated graphene oxide (s-GO). Some examples of suitable cations may include sodium (Na⁺), potassium (K⁺), zirconium (Zr⁴⁺), cesium (Ce³⁺), and the like. These cations may be washed away from the selective transport layer 40 after fabrication.

The selective transport layer 40 can be formed and/or placed using a wet coating method by direct coating or decal transferring. When using direct coating, the dispersion including graphene oxide (GO) and the sulfonated graphene oxide (s-GO) can be directly applied to the PEM 38 or the electrode (34 or 36). After being applied to the PEM 38 or the electrode (34 or 36), the dispersion can be heated and/or cured to form the selective transport layer 40. When using decal transferring, the dispersion may be applied to a sacrificial substrate, heated and/or removed from the sacrificial substrate, and applied to the PEM 38 to form the selective transport layer 40. In some instances, the selective transport layer 40 may be formed within the PEM 38, for example as a layer or as discrete portions.

Next, block 104 depicts placing a first electrode layer 34 on the selective transport layer 40. The first electrode layer 34 may be formed by preparing a catalyst ink by mixing, for example, platinum nanoparticles, a carbon support, a binder, and a solvent. The catalyst ink is then applied to the selective transport layer 40 and/or the proton exchange membrane 38 using, for example, spraying, painting, or screen printing. This application forms a thin, uniform ink catalyst layer on the cathode side. After application, the catalyst ink layer is dried to remove the solvent and form the first electrode layer 34 and electrode layer. In some cases, a sintering process is used to improve the adhesion and conductivity of the catalyst ink layer. A final step may involve hot pressing the first electrode layer 34, the selective transport layer 40, and/or the PEM 38 to ensure good contact between each respective layer and to enhance the mechanical stability of the MEA.

Block 106 depicts placing a second electrode layer 36 on a second side of the proton exchange membrane 38, wherein the second side is opposite or distal from the first side. The second electrode layer 36 may be formed similarly to the first electrode layer 34. The second electrode layer 36 may be formed by preparing a catalyst ink by mixing, for example, platinum nanoparticles, a carbon support, a binder, and/or a solvent. The catalyst ink is then applied to the selective transport layer 40 and/or the proton exchange membrane 38 using, for example, spraying, painting, or screen printing. This application forms a thin, uniform ink catalyst layer on the anode side. After application, the catalyst ink layer is dried to remove the solvent and form the second electrode layer 36 and electrode layer. In some cases, a sintering process is used to improve the adhesion and conductivity of the catalyst ink layer. A final step may involve hot pressing the second electrode layer 36, the selective transport layer 40, and/or the PEM 38 to ensure good contact between each respective layer and to enhance the mechanical stability of the MEA.

The membrane electrode assembly and membrane electrode assembly (MEA) 24 of the present disclosure is advantageous and beneficial over prior art. The graphene oxide (GO), a highly oxidized form of graphene, used in the membrane electrode assembly 24 disclosed herein, offers solution for allowing favorable chemical species (e.g., protons and water) to pass through the proton exchange membrane 38 within a membrane electrode assembly 24 and, at the same time, hinder transport of unfavorable chemical species (e.g., H₂, O₂, N₂, Pt²⁺ ions, and the like). While maintaining a two-dimensional morphology, GO materials are significantly more porous and permeable to transport species. The membrane electrode assembly, a fuel cell, and a process for forming the membrane electrode assembly disclosed herein leverage the unique properties of graphene oxides to achieve better transport selectivity and durability and mitigate membrane electrode assembly degradation.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A membrane electrode assembly, comprising:
a first electrode layer including a cathode layer;
a second electrode layer including an anode layer;
a proton exchange membrane extending between the first electrode layer and the second electrode layer; and
a selective transport layer supported by the proton exchange membrane, wherein the selective transport layer includes a composite formed from graphene oxide (GO) and sulfonated-graphene oxide (s-GO).

2. The membrane electrode assembly of claim 1, wherein the proton exchange membrane is formed of at least one of perfluorosulfonic acid (PFSA) polymer, a hydrocarbon-based polymer, a sulfonated aromatic polymer, a composite membrane, or a metal-organic framework (MOF).

3. The membrane electrode assembly of claim 1, wherein the proton exchange membrane is between 5 and 200 microns (μm) in thickness.

4. The membrane electrode assembly of claim 1, wherein the proton exchange membrane is reinforced with at least one of expanded polytetrafluoroethylene (ePFTE) or electrospun fibers.

5. The membrane electrode assembly of claim 1, wherein the thickness of the selective transport layer is between 100 and 1000 times smaller than the thickness of the proton exchange membrane.

6. The membrane electrode assembly of claim 1, wherein the GO and/or the s-GO materials used in the selective transport layer is partially reduced.

7. The membrane electrode assembly of claim 1, wherein the selective transport layer includes a weight ratio of graphene oxide (GO) to sulfonated-graphene oxide (s-GO) of between 0.3 to 3.

8. The membrane electrode assembly of claim 1, wherein the selective transport layer has a sheet size of greater than one micron (μm), a sheet thickness of less than one nanometer (nm), a sulfur content between 4-10 wt. %, and an oxygen content of between 10-30 wt. %.

9. The membrane electrode assembly of claim 1, wherein the selective transport layer is disposed proximate the first electrode layer.

10. The membrane electrode assembly of claim 1, wherein the selective transport layer is disposed proximate the second electrode layer.

11. The membrane electrode assembly of claim 1, wherein the selective transport layer is disposed at multiple locations within the proton exchange membrane.

12. The membrane electrode assembly of claim 1, wherein two selective transport layers confine a gas recombination layer in the membrane.

13. The membrane electrode assembly of claim 1, wherein the selective transport layer varies in thickness across an active area of the selective transport layer.

14. The membrane electrode assembly of claim 12, wherein the selective transport layer is absent in a non-active region to facilitate water transfer.

15. The membrane electrode assembly of claim 12, wherein the selective transport layer is thinner at an anode/selective transport layer interface proximate a cathode inlet.

16. The membrane electrode assembly of claim 1, further comprising:
an ionomer coated on at least one of the first electrode layer or the second electrode layer, wherein the ionomer is less than one micron in thickness.

17. A fuel cell for a vehicle, comprising:
a membrane electrode assembly including
a first electrode layer including a cathode layer;
a second electrode layer including an anode layer;
a proton exchange membrane extending between the first electrode layer and the second electrode layer, wherein the proton exchange membrane includes a perfluorosulfonic acid (PFSA) polymer; and
a selective transport layer supported by the proton exchange membrane, wherein the selective transport layer includes a composite formed from graphene oxide (GO) and sulfonated-graphene oxide (s-GO), and wherein the selective transport layer is disposed between the cathode layer and the proton exchange membrane;
a first porous transport layer adjacent to the membrane electrode assembly and the first electrode layer;
a first separator plate disposed adjacent to the first porous transport layer;
a second porous transport layer adjacent to the membrane electrode assembly and the second electrode layer and distal from the first porous transport layer; and
a second separator plate disposed adjacent to the second porous transport layer.

18. The fuel cell of claim 16, wherein the selective transport layer includes GO and s-GO materials with a sheet size of greater than one micron (μm), a sheet thickness of less than one nanometer (nm), a sulfur content between 4-20 wt. %, and an oxygen content of between 5-30 wt. %.

19. A method for forming a membrane electrode assembly, comprising
forming a selective transport layer on a first side of a proton exchange membrane, wherein the selective transport layer includes a composite formed from graphene oxide (GO) and sulfonated-graphene oxide (s-GO);
placing a first electrode layer on the selective transport layer; and
placing a second electrode layer on a second side of the proton exchange membrane, wherein the second side is opposite the first side.

20. The method in claim 19, wherein the first electrode layer is a cathode, and the second electrode layer is an anode.
